(19) United States
(12) Patent Application Publication
(10) Pub. No.: US 2026/0361846 A1
(43) Pub. Date: Nov. 12, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US); Peking University, Beijing (CN)

(72) Inventors: Wu LIU, Beijing (CN); Huiwen REN, Beijing (CN); Zhao WANG, Beijing (CN); Yuwen HE, Los Angeles, CA (US); Siwei MA, Beijing (CN); Li ZHANG, Los Angeles, CA (US)

(21) Appl. No.: 19/724,690

(22) Filed: Jun. 29, 2026

Related U.S. Application Data
(63) Continuation of application No. PCT/CN2024/143382, filed on Dec. 27, 2024.

(30) Foreign Application Priority Data
Dec. 29, 2023 (WO) PCT/CN2023/143492

(51) Int. Cl. H04N 19/103; H04N 19/137

(52) U.S. Cl. CPC H04N 19/103; H04N 19/137

(57) ABSTRACT

Embodiments of the present disclosure provide a solution for video processing. In a method for video processing, for a conversion between a video unit of a video and a bitstream of the video, a first predicted value associated with at least one partition mode is determined according to a first model and based on first feature information of the video unit. A second predicted value associated with the at least one partition mode is determined according to a second model and based on second feature information of the video unit. A decision regarding whether to apply the at least one partition mode is determined based on the first predicted value and the second predicted value. The conversion is performed based on the decision.

### CROSS-REFERENCE TO RELATED APPLICATIONS

This application is a continuation of International Application No. PCT/CN2024/143382, filed on Dec. 27, 2024, which claims the benefit of International Application No. PCT/CN2023/143492 filed on Dec. 29, 2023. The entire contents of these applications are hereby incorporated by reference in their entireties.

### FIELDS

Embodiments of the present disclosure relates generally to video processing techniques, and more particularly, to partition mode decision.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, a first predicted value associated with at least one partition mode according to a first model and based on first feature information of the video unit; determining a second predicted value associated with the at least one partition mode according to a second model and based on second feature information of the video unit; determining a decision regarding whether to apply the at least one partition mode for the video unit based on the first predicted value and the second predicted value; and performing the conversion based on the decision. The method in accordance with the first aspect of the present disclosure decides whether to apply or skip the at least one partition mode by using predicted values of two models. The coding performance and coding efficiency can be thus improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a first predicted value associated with at least one tree partition mode according to a first model and based on first feature information of a video unit of the video; determining a second predicted value associated with the at least one tree partition mode according to a second model and based on second feature information of the video unit; determining a decision regarding whether to apply the at least one partition mode for the video unit based on the first predicted value and the second predicted value; and generating the bitstream based on the decision.

In a fifth aspect, a method for storing a bitstream of a video is proposed. The method comprises: determining a first predicted value associated with at least one tree partition mode according to a first model and based on first feature information of a video unit of the video; determining a second predicted value associated with the at least one tree partition mode according to a second model and based on second feature information of the video unit; determining a decision regarding whether to apply the at least one partition mode for the video unit based on the first predicted value and the second predicted value; generating the bitstream based on the decision; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a schematic diagram of a network structure in accordance with some embodiments of the present disclosure;

FIG. 5A and FIG. 5B illustrate schematic diagrams of a thermal map analysis for a horizontal feature analysis and a thermal map analysis for a vertical feature analysis in accordance with some embodiments of the present disclosure, respectively;

FIG. 6 illustrates a flowchart of a method for video processing in accordance with embodiments of the present disclosure; and

FIG. 7 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

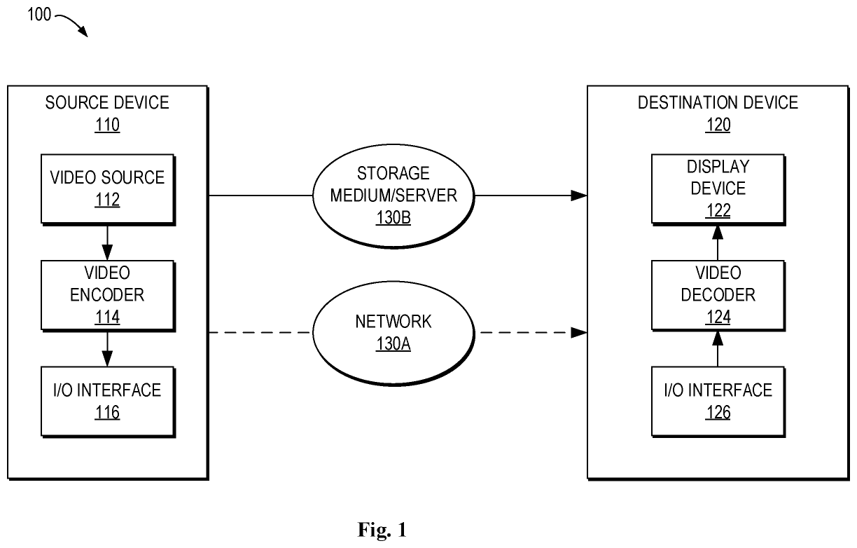

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

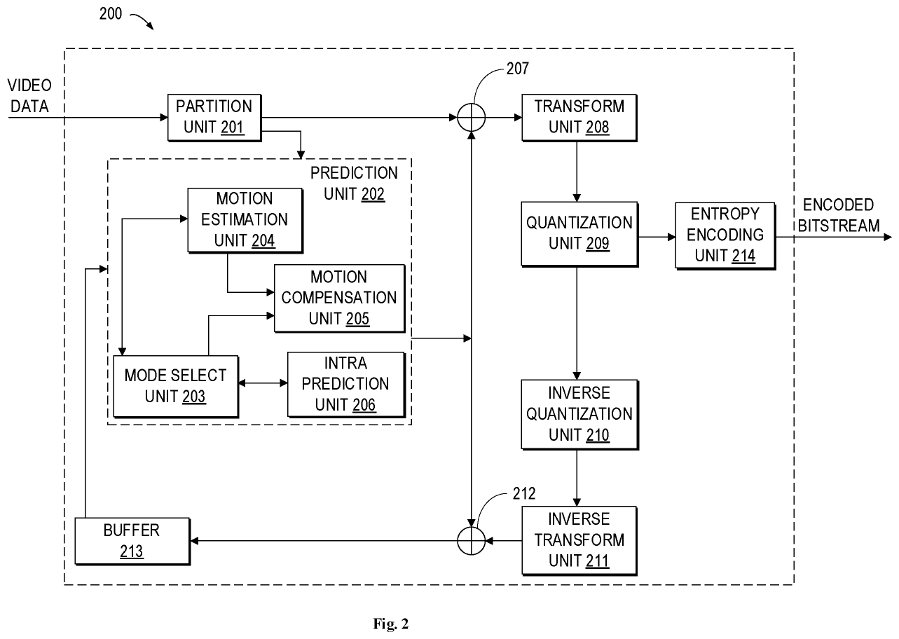

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

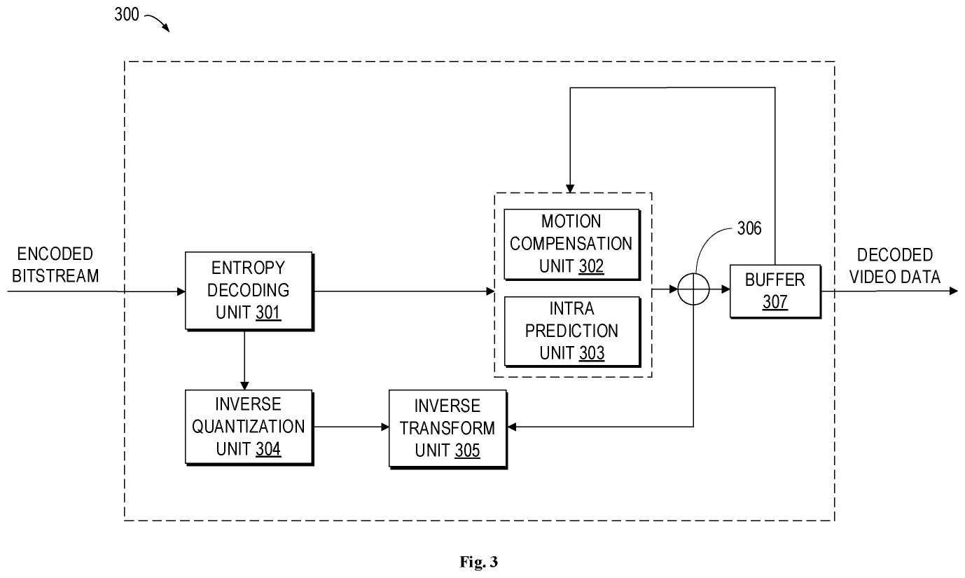

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Introduction

With the rapid development of multimedia technology, new video formats such as Ultra High Definition (UHD) and Virtual Reality (VR) that can provide more realistic visual experiences continue to emerge. However, this is accompanied by an exponential growth in video data volume, posing severe challenges to the storage and transmission of video data. In order to meet future market demands, the Joint Video Exploration Team (JVET) introduced the next-generation video coding standard, VVC in 2022. Compared to the previous generation standard High Efficiency Video Coding (HEVC), VVC exhibits an improvement in coding performance by nearly 40% while maintaining the subjective video quality unchanged. This improvement is attributed to a series of advanced encoding tools introduced by VVC, such as the Quadtree Multi-Type Tree (QTMT) partition structure. However, the introduction of these new tools has brought additional computational complexity. For instance, in the same All Intra configuration for intra coding, the computational complexity of the VVC Test Model (VTM) is nearly 18 times higher than that of the HEVC Test Model (HM). Currently, due to the excessively high computational complexity, VVC faces application difficulties in real-time scenarios such as unmanned aerial vehicles and live video streaming without good encoder optimizations to reduce the computation complexity greatly.

Regarding the QTMT structure, in order to support more flexible block partition shapes, based on HEVC, VVC increases the partition mode per CU to five kinds: Quadtree partitioning, Horizontal and vertical binary tree partitioning, Horizontal and vertical ternary tree partitioning. VVC evaluates these five partition modes and selects the optimal one for encoding. Due to the need to calculate the cost of each mode, this QTMT partitioning process constitutes over 97% of the encoding time. Among them, it is worth noting that the binary tree partition accounts for the largest proportion of computation time, more than 50%, so the binary tree partition acceleration is an interesting point. If the optimal mode can be predicted in advance, skipping unnecessary computations, a substantial reduction in computational workload can be achieved.

With the powerful potential gradually revealed by deep learning in the field of image processing, an increasing number of scholars are applying deep learning for encoder optimization. The fast algorithms on VVC can be broadly categorized into the following two aspects: Methods not based on learning and methods based on learning.

### Non-Learning Based Fast Method

Non-learning-based approaches tend to use simple decisions with little additional time, but also suffer from low accuracy. For example, the Sobel operator was utilized to extract the gradient and variance values of a CU to determine whether the texture of the CU is smooth. If smooth, further partitioning is skipped. To balance VVC computational complexity and coding efficiency, the Canny edge detector may be employed for intra-frame coding. Edge features for each CU may be extracted and this information may be used to skip vertical or horizontal partition modes. For inter-frame coding, a three-frame difference method was applied to identify whether the current block is a moving object, allowing the premature termination of partitioning for non-moving blocks.

### Learning-Based VVC Fast Algorithms

The use of learning models can make nonlinear predictions and obtain higher accuracy, but the extra time caused by model calculation is a problem that cannot be ignored, which also limits the size of the model. For example, each CU was divided into 8×8 small blocks and a designed convolutional neural network was used to calculate the predicted depth for each small block. This approach allows for the premature skipping of unnecessary partitions. A new Convolutional Neural Network (CNN) called Multi-Level Tree CNN (MLT-CNN) was designed, which takes the luma information of the entire CU as input to predict the optimal partition mode in advance.

### 2. Problem Statement

Fraunhofer Versatile Video Encoder, i.e., VVenC. VVenC features a redesigned encoder architecture, SIMD instruction set optimization, and support for multithreading, built upon the VTM codebase. Even after the accelerated optimization of VVenC, the computational complexity of its QTMT module is still quite high, especially the calculation of binary tree partition, which seriously hinders the application of VVenC in real-time scenarios.

In addition, compared with traditional methods, the learning-based method has significantly improved prediction accuracy and can effectively balance quality loss and coding acceleration. However, there are also the following obvious defects:
1. With respect to the real-time video coding applications, these learning-based methods all use larger models to make predictions in order to obtain higher prediction accuracy. However, the additional computational complexity introduced by the model is too large to be ignored, which is against to the goal of real time application.
2. For forecasts in two different directions (horizontal and vertical), using the same model and the same features tends to introduce serious errors.
3. The above method does not take into account the correlation between horizontal and vertical decisions, which also leads to a certain loss of prediction.
3. Proposed Solutions

The proposed a fast binary-tree partition decision method based on separate fully connected neural networks, aiming to significantly reduce the model parameter count. A simple fully connected neural network is constructed, virtually introducing no additional model computation time. Additionally, this method allows for easy integration of the network model into VVenC through straightforward mathematical calculations. Specifically, the proposed method is as follows: First, encoding process information is saved for a dataset extraction, and correlation analysis is conducted on the dataset to select the encoding information most correlated with the optimal partition mode as the input feature for the model. Subsequently, the designed fully connected network model undergoes an offline training to obtain model parameters. Finally, the model parameters are used for tree partition prediction within the encoder. Based on the feature information of the current partition mode, the probability of the current partition mode being the optimal mode can be determined, thus whether to skip the computation of this mode in advance is decided to accelerate the block partitioning process.

Because the information required is different in the horizontal and vertical directions, and the most relevant features will be different in different directions, two separate models are designed. The correlation analysis of the two models is carried out, respectively, and the corresponding model input characteristics and model structure are obtained. Finally, combined with the predicted values of the two models, the final tree partition mode skipping decision is made.

### 3.1 the Proposed Separate Fully Connected Neural Networks

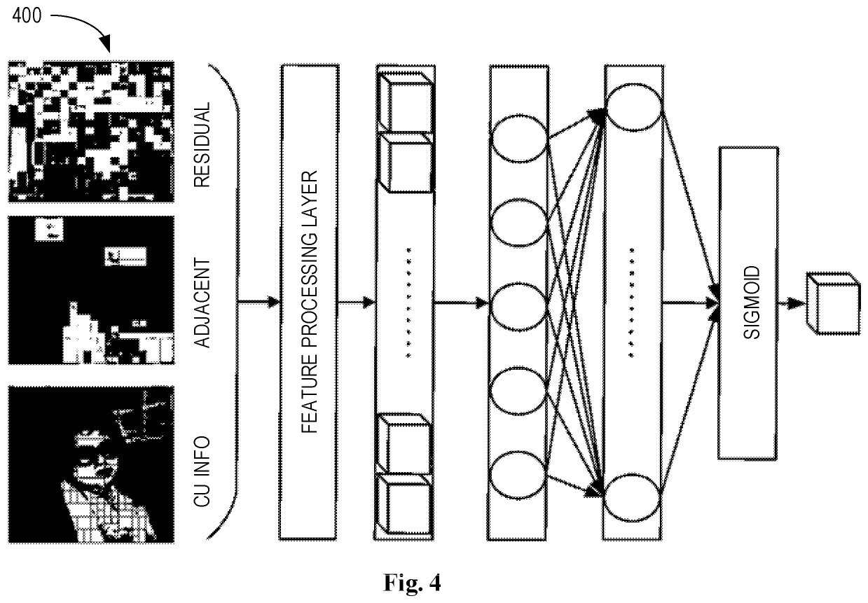

FIG. 4 illustrates a schematic diagram of a network structure 400 in accordance with some embodiments of the present disclosure. As shown in FIG. 4, firstly, the CU information and residual information of the current mode are obtained, and then processed in the feature processing layer to generate input features using the calculation methods described in section 3.2. Subsequently, the obtained features are passed through simple fully connected layers with activation functions, ultimately producing prediction results in the output layer.

Since the horizontal and vertical features obtained by feature analysis are different, the two models are trained separately: Horizontal model: 6*15*15*1 (6 neurons in the input layer, two hidden layers of 15 neurons in the middle, 1 neuron in the output layer). Vertical model: 5*15*15*1.

### 3.2 Separate Model

In order to obtain the optimal features corresponding to the two models respectively, a detailed feature analysis is conducted. The intermediate encoding information and optimal partitioning information as dataset are saved. Then, heatmap feature analysis is performed on the dataset to assess the correlation of each feature with the optimal mode. Finally, features are selected based on their correlations with the optimal partitioning mode, from high to low.

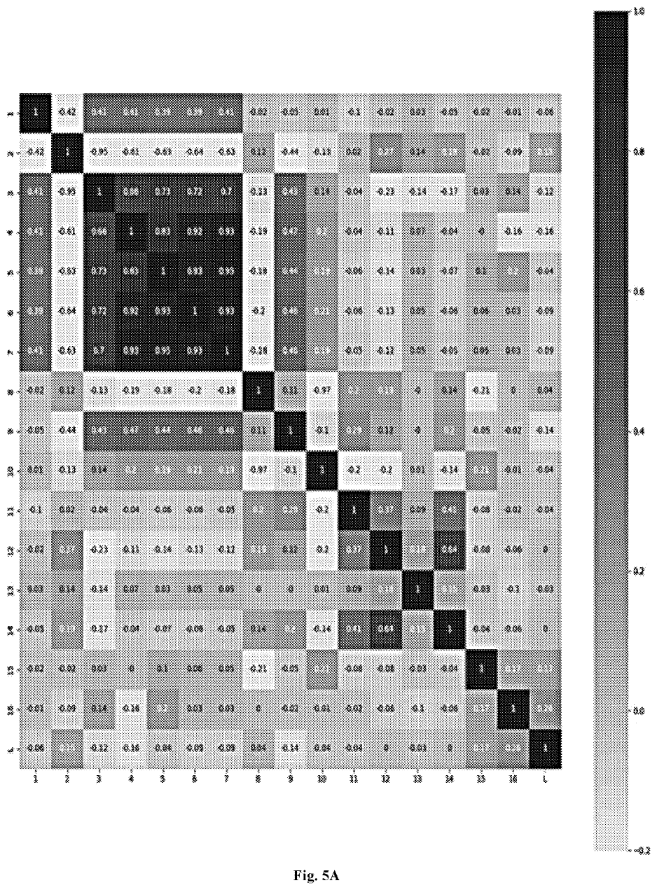

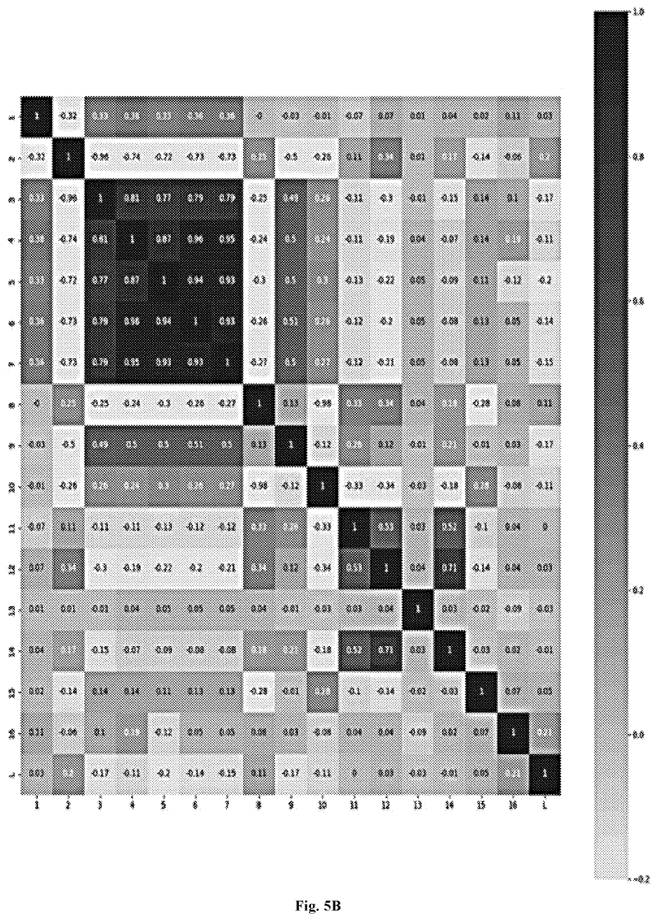

FIG. 5A and FIG. 5B shows thermal map analysis in accordance with some embodiments of the present disclosure. FIG. 5A illustrates a schematic diagram of horizontal feature analysis and FIG. 5B illustrates a schematic diagram of vertical feature analysis. FIG. 5A and FIG. 5B show the correlation between each feature pair and the correlation between each feature and the optimal partitioning pattern (last line).

BVI-DVC is chosen as the training sequence set. Heatmap analysis is performed on the dataset, resulting in the analysis shown in FIG. 5A and FIG. 5B. In FIG. 5A and FIG. 5B, the numbers represent feature identifiers, and ‘L’ represents the optimal partitioning mode. The heatmap analyzes the correlation between 16 features and the optimal partitioning mode. It can be seen from FIG. 5A and FIG. 5B that the feature correlations of horizontal and vertical directions are not similar, which also proves the correctness of separating the horizontal and vertical models. Based on the correlation between features and the optimal partitioning pattern, and the correlation between features, the final input features may be determined as follows:
Horizontal input features: Quantization Parameter (QP), QTMT Depth (Depth), Coding Block Flag (CBF), Mean of Residuals (Mean_Res), Residual Variance Comparison Value (Com_Var), Horizontal-Vertical Gradient Comparison Value (Com_Grad).
Vertical input features: Quantization Parameter (QP), QTMT Depth (Depth), Vertical gradient (Grad), Mean of Residuals (Mean_Res), Horizontal-Vertical Gradient Comparison Value (Com_Grad).

While the calculation methods for the features are as follows:
Grad: Gradient values effectively represent the motion trend in a specific direction. The specific calculation formula is as follows:

$${G}_{h} = {\sum }_{i = 0}^{H - 1} {\sum }_{j = 0}^{W - 1} \vert {O}_{i , j + 1} - {O}_{i , j} \vert$$

$${G}_{v} = {\sum }_{i = 0}^{H - 1} {\sum }_{j = 0}^{W - 1} \vert {O}_{i + 1 , j} - {O}_{i , j} \vert .$$

Where, Gₕ represents the horizontal gradient, Gᵥ represents the vertical gradient, H and W represent the height and width of the current CU, and O_{i,j} represents the luma value of the pixel point (i, j).
Mean_Res: Residual values represent the predicted change in pixel values. However, block partitioning often groups pixels with similar changes into the same block. Therefore, when the residuals for sub-blocks obtained after partitioning is smaller, the block partitioning is more necessary. The calculation method for pixel residuals is as follows:

R_{i,j}=|P_{i,j}−O_{i,j}|.

Where R_{i,j} represents the residual value and P_{i,j} represents the prediction value.
Com_Var: Judging from only one direction can lead to significant prediction errors. Therefore, comparing partition modes in two different directions (horizontal and vertical) is to identify the mode with the maximum sub-block residual variance. Then, by comparing, skip the partition mode with higher sub-block residual variance. The calculation method for this feature is as follows:

$$HCom\_Var = \{ \begin{matrix}0 , & Var\_H > Var\_V \\ 1 , & Var\_H < Var\_V\end{matrix}$$

$$VCom\_Var = \{ \begin{matrix}0 , & Var\_V > Var\_H \\ 1 , & Var\_V < Var\_H\end{matrix} .$$

Where, Var_H represents the horizontal maximum subblock residual variance, and Var_V represents the vertical maximum subblock residual variance. HCom_Var is the horizontal feature and VCom_Var is the vertical feature.
Com_Grad: Similar to the feature Com_Var, using a comparison value is more beneficial for reducing prediction errors. The calculation method is as follows:

$$HCom\_Grad = \{ \begin{matrix}0 , & {G}_{h} > {G}_{v} \\ 1 , & {G}_{h} < {G}_{v}\end{matrix}$$

$$VCom\_Grad = \{ \begin{matrix}0 , & {G}_{v} > {G}_{h} \\ 1 , & {G}_{v} < {G}_{h}\end{matrix} .$$

Where Gₕ represents the horizontal gradient and Gᵥ represents the vertical gradient. HCom_Grad is the horizontal feature and VCom_Grad is the vertical feature.

### 3.3 Joint Decision

The algorithm proposed in the present disclosure aims to reduce the unnecessary Rdcost calculation during the search for the optimal partition mode, thereby lowering computational complexity. Before performing binary tree partition calculations, predictions are made using the horizontal and vertical models, resulting in two predicted values. These predicted values are then combined to selectively skip horizontal or vertical partition calculations based on the following specific rules:
1) If the predicted value is less than 0.5: When both predictions are less than 0.3, both patterns are skipped. When a predicted value is less than 0.3 and a predicted value is greater than 0.3, both are skipped when the difference between the two predicted values is less than 0.1. When one predicted value is less than 0.3 and one predicted value is greater than 0.3, the smaller one is skipped when the difference between the two predicted values is greater than 0.1. When both predicted values are greater than 0.3, the pattern with a small predicted value is skipped.
2) If the predicted value is greater than 0.5: When the difference between the two predicted values is greater than 0.2, the pattern with a small predicted value is skipped. If the difference between the two predicted values is less than 0.2, neither is skipped.

### 3.4 Detail Solutions

1. Models are constructed in the horizontal and vertical directions respectively, and the two models are trained separately.
2. Method of feature extraction, the correlation between two features is used for feature selection. The most relevant features are selected.
3. Lightweight model structure, almost no additional time, easy to embed the model in the test software.
4. The combined determination of the predicted values of the two models further increases the prediction accuracy.

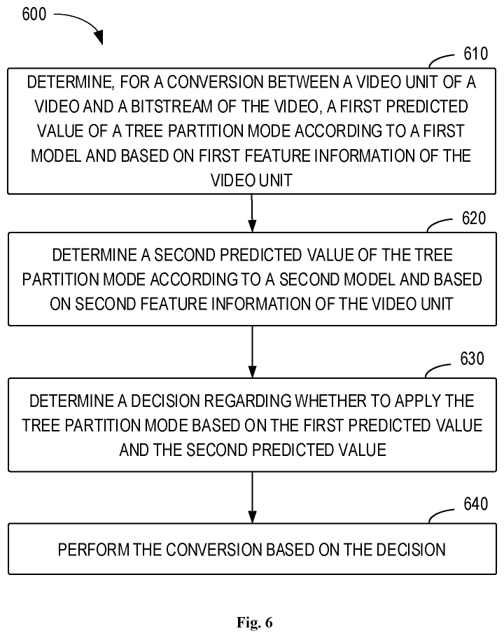

FIG. 6 illustrates a flowchart of a method 600 for video processing in accordance with embodiments of the present disclosure. The method 600 is implemented during a conversion between a video unit of a video and a bitstream of the video.

At block 610, for a conversion between a video unit of a video and a bitstream of the video, a first predicted value associated with at least one partition mode is determined according to a first model and based on first feature information of the video unit. For example, the at least one partition mode may be at least one tree partition mode such as binary-tree partition mode.

At block 620, a second predicted value associated with the at least one partition mode is determined according to a second model and based on second feature information of the video unit.

At block 630, a decision regarding whether to apply the at least one partition mode for the video unit is determined based on the first predicted value and the second predicted value.

At block 640, the conversion is performed based on the decision. In some embodiments, the conversion includes decoding the video unit from the bitstream. Alternatively, or in addition, in some embodiments, the conversion includes encoding the video unit into the bitstream. For example, the decision may be used for the encoding. That is, in the encoding process, whether to apply or skip a partition mode may be determined based on the first and second predicted value.

The method 600 enables determining to apply or skip a partition mode by combined determination of two predicted values of two models. In this way, the prediction accuracy for the partition mode decision can be increased.

In some embodiments, the method 600 further comprises: constructing the first model in a horizontal direction; and constructing the second model in a vertical direction. That is, the first model may be a horizontal model and the second model may be a vertical model.

In some embodiments, the first model comprises six neurons in an input layer, two hidden layers of fifteen neurons in a middle layer and one neural in an output layer, and the second model comprises five neurons in an input layer, two hidden layers of fifteen neurons in a middle layer and one neural in an output layer. For example, the first model and the second model may use the network structure as shown in FIG. 4.

In some embodiments, the first and second models are offline trained separately. Models may be constructed in the horizontal and vertical directions respectively, and trained separately.

In some embodiments, the first and second models are fully connected network models. In this way, the first and second models may use lightweight model structure with almost no additional time. In addition, it is easy to embed the model in the test software. The input parameters of the first and second models are less, thus may achieve a nearly real-time processing.

In some embodiments, the method 600 further comprises: storing coding information for extracting a dataset; and performing a correlation analysis on the dataset to determine the first feature information and the second feature information from the coding information.

In some embodiments, the coding information comprises encoding information, the dataset further stores optimal partitioning information, and the first feature information and the second feature information are selected based on correlation information of the encoding information and the optimal partitioning information.

In some embodiments, the correlation information is determined by a heatmap feature analysis based on the encoding information and the optimal partitioning information in the dataset. In this way, the correlation between two features is used for feature selection. The most relevant features are selected.

In some embodiments, the first feature information comprises at least one of: a quantization parameter (QP), a quadtree multi-type tree (QTMT) depth, a coding block flag (CBF), a mean of residuals, a residual variance comparison value, or a horizontal-vertical gradient comparison value.

In some embodiments, the first feature information comprises at least one of: a quantization parameter (QP), a quadtree multi-type tree (QTMT) depth, a vertical gradient, a mean of residuals, or a horizontal-vertical gradient comparison value.

In some embodiments, the vertical gradient represents a motion trend in a vertical direction, and the vertical gradient is determined by:

$${G}_{v} = {\sum }_{i = 0}^{H - 1} {\sum }_{j = 0}^{W - 1} \vert {O}_{i + L j} - {O}_{i , j} \vert ,$$

where Gᵥ represents the vertical gradient, H and W represent a height and a width of the video unit, and O_{i,j} represents a luma value of a pixel point (i, j).

In some embodiments, the mean of residuals represents a predicted change in pixel values, and the mean of residuals is determined by: R_{i,j}=|P_{i,j}−O_{i,j}|, where R_{i,j} denotes a residual value of a pixel point (i, j), P_{i,j} denotes a prediction value of the pixel point (i, j), and O_{i,j} denotes a luma value of the pixel point (i, j).

In some embodiments, the residual variance comparison value is based on a horizontal feature and a vertical feature, the horizontal feature and the vertical feature being determined by

$$HCom\_Var = \{ \begin{matrix}0 , & Var\_H > Var\_V \\ 1 , & Var\_H < Var\_V\end{matrix}$$

$$VCom\_Var = \{ \begin{matrix}0 , & Var\_V > Var\_H \\ 1 , & Var\_V < Var\_H\end{matrix} ,$$

where Var_H represents a horizontal maximum subblock residual variance, Var_V represents a vertical maximum subblock residual variance, HCom_Var represents the horizontal feature, and VCom_Var represents the vertical feature.

In some embodiments, the horizontal-vertical gradient comparison value is based on a horizontal value and a vertical value, the horizontal value and the vertical value being determined by:

$$HCom\_Grad = \{ \begin{matrix}0 , & {G}_{h} > {G}_{v} \\ 1 , & {G}_{h} < {G}_{v}\end{matrix}$$

$$VCom\_Grad = \{ \begin{matrix}0 , & {G}_{v} > {G}_{h} \\ 1 , & {G}_{v} < {G}_{h}\end{matrix} ,$$

wherein Gₕ represents a horizontal gradient, Gᵥ represents a vertical gradient, HCom_Grad represents the horizontal value, and VCom_Grad represents the vertical value.

It is to be understood that these calculations and parameters described are only for the purpose of illustration, without suggesting any limitation. Any suitable calculation or parameter may be applied.

In some embodiments, determining the decision regarding whether to apply the at least one partition mode comprises: in accordance with a determination that the first and second predicted values are less than a first threshold, determining the decision that a first partition mode and a second partition mode are skipped.

In some embodiments, determining the decision regarding whether to apply the at least one partition mode further comprises: in accordance with a determination that the first predicted value is less than the first threshold and the second predicted value is larger than or equal to the first threshold and less than a second threshold, determining whether a difference between the first and second predicted values is less than a third threshold; in accordance with a determination that the difference is less than the third threshold, determining the decision that the first partition mode and the second partition mode are skipped; and in accordance with a determination that the difference is larger than or equal to the third threshold, determining the decision that the first partition mode is skipped and the second partition mode is to be applied. For example, the first threshold may be 0.3, the second threshold may be 0.5 and the third threshold may be 0.1.

In some embodiments, determining the decision regarding whether to apply the at least one partition mode comprises: in accordance with a determination that the first and second predicted values are larger than a second threshold, determining whether a difference between the first and second predicted values is less than a fourth threshold; in accordance with a determination that the difference is larger than the fourth threshold, determining the decision that a partition mode of a first and second partition modes corresponding to a smaller predicted value of the first and second predicted values is skipped and another partition mode is to be applied; and in accordance with a determination that the difference is less than or equal to the fourth threshold, determining the decision that the first and second partition modes are to be applied. For example, the second threshold may be 0.5 and the fourth threshold may be 0.2.

In some embodiments, the first partition mode comprises a horizontal partition mode and the second partition mode comprises a vertical partition mode. That is, whether to apply or skip the horizontal partition mode and/or the vertical partition mode may be determined based on the first and second predicted values as described above. It is to be understood that although two partition modes of two directions are described in some example embodiments of the present disclosure, in some other embodiments, more than two partition modes for more than two directions may be applied in a similar way. For example, other directions such as a direction from a left-top to right-bottom or a direction from a right-top to a left-right may be applicable.

It is to be understood that these thresholds and determination rules for the at least one prediction mode are only for the purpose of illustration, without suggesting any limitation. Any suitable threshold or rule may be applied.

It is to be understood that although two models are used in some example embodiments of the present disclosure, in some other embodiments, more than two models for more than two directions may be applied in a similar way. The number of models may be based on the number of partition modes for different directions. Scope of the present disclosure is not limited in this regard.

According to further embodiments of the present disclosure, a non-transitory computer-readable recording medium is provided. The non-transitory computer-readable recording medium stores a bitstream of a video which is generated by a method performed by an apparatus for video processing. In the method, a first predicted value associated with at least one tree partition mode is determined according to a first model and based on first feature information of a video unit of the video. A second predicted value associated with the at least one tree partition mode is determined according to a second model and based on second feature information of the video unit. A decision regarding whether to apply the at least one partition mode for the video unit is determined based on the first predicted value and the second predicted value. The bitstream is generated based on the decision.

According to still further embodiments of the present disclosure, a method for storing bitstream of a video is provided. In the method, a first predicted value associated with at least one tree partition mode is determined according to a first model and based on first feature information of a video unit of the video. A second predicted value associated with the at least one tree partition mode is determined according to a second model and based on second feature information of the video unit. A decision regarding whether to apply the at least one partition mode for the video unit is determined based on the first predicted value and the second predicted value. The bitstream is generated based on the decision. The bitstream is stored in a non-transitory computer-readable recording medium.

Implementations of the present disclosure can be described in view of the following clauses, the features of which can be combined in any reasonable manner.

Clause 1. A method of video processing, comprising: determining, for a conversion between a video unit of a video and a bitstream of the video, a first predicted value associated with at least one partition mode according to a first model and based on first feature information of the video unit; determining a second predicted value associated with the at least one partition mode according to a second model and based on second feature information of the video unit; determining a decision regarding whether to apply the at least one partition mode for the video unit based on the first predicted value and the second predicted value; and performing the conversion based on the decision.

Clause 2. The method of clause 1, further comprising: constructing the first model in a horizontal direction; and constructing the second model in a vertical direction.

Clause 3. The method of clause 2, wherein the first model comprises six neurons in an input layer, two hidden layers of fifteen neurons in a middle layer and one neural in an output layer, and the second model comprises five neurons in an input layer, two hidden layers of fifteen neurons in a middle layer and one neural in an output layer.

Clause 4. The method of any of clauses 1-3, wherein the first and second models are offline trained separately.

Clause 5. The method of any of clauses 1-4, wherein the first and second models are fully connected network models.

Clause 6. The method of any of clauses 1-5, further comprising: storing coding information for extracting a dataset; and performing a correlation analysis on the dataset to determine the first feature information and the second feature information from the coding information.

Clause 7. The method of clause 6, wherein the coding information comprises encoding information, the dataset further stores optimal partitioning information, and the first feature information and the second feature information are selected based on correlation information of the encoding information and the optimal partitioning information.

Clause 8. The method of clause 7, wherein the correlation information is determined by a heatmap feature analysis based on the encoding information and the optimal partitioning information in the dataset.

Clause 9. The method of any of clauses 1-8, wherein the first feature information comprises at least one of: a quantization parameter (QP), a quadtree multi-type tree (QTMT) depth, a coding block flag (CBF), a mean of residuals, a residual variance comparison value, or a horizontal-vertical gradient comparison value.

Clause 10. The method of any of clauses 1-9, wherein the first feature information comprises at least one of: a quantization parameter (QP), a quadtree multi-type tree (QTMT) depth, a vertical gradient, a mean of residuals, or a horizontal-vertical gradient comparison value.

Clause 11. The method of clause 10, wherein the vertical gradient represents a motion trend in a vertical direction, and the vertical gradient is determined by:

$${G}_{v} = {\sum }_{i = 0}^{H - 1} {\sum }_{j = 0}^{W - 1} \vert {O}_{i + 1 , j} - {O}_{i , j} \vert ,$$

wherein Gᵥ represents the vertical gradient, H and W represent a height and a width of the video unit, and O_{i,j} represents a luma value of a pixel point (i, j).

Clause 12. The method of clause 9 or 10, wherein the mean of residuals represents a predicted change in pixel values, and the mean of residuals is determined by: R_{i,j}=|P_{i,j}−O_{i,j}|, wherein R_{i,j} denotes a residual value of a pixel point (i, j), P_{i,j} denotes a prediction value of the pixel point (i, j), and O_{i,j} denotes a luma value of the pixel point (i, j).

Clause 13. The method of clause 9, wherein the residual variance comparison value is based on a horizontal feature and a vertical feature, the horizontal feature and the vertical feature being determined by:

$$HCom\_Var = \{ \begin{matrix}0 , & Var\_H > Var\_V \\ 1 , & Var\_H < Var\_V\end{matrix}$$

$$VCom\_Var = \{ \begin{matrix}0 , & Var\_V > Var\_H \\ 1 , & Var\_V < Var\_H\end{matrix} ,$$

wherein Var_H represents a horizontal maximum subblock residual variance, Var_V represents a vertical maximum subblock residual variance, HCom_Var represents the horizontal feature, and VCom_Var represents the vertical feature.

Clause 14. The method of clause 9 or 10, wherein the horizontal-vertical gradient comparison value is based on a horizontal value and a vertical value, the horizontal value and the vertical value being determined by:

$$HCom\_Grad = \{ \begin{matrix}0 , & {G}_{h} > {G}_{v} \\ 1 , & {G}_{h} < {G}_{v}\end{matrix}$$

$$VCom\_Grad = \{ \begin{matrix}0 , & {G}_{v} > {G}_{h} \\ 1 , & {G}_{v} < {G}_{h}\end{matrix} ,$$

wherein Gₕ represents a horizontal gradient, Gᵥ represents a vertical gradient, HCom_Grad represents the horizontal value, and VCom_Grad represents the vertical value.

Clause 15. The method of any of clauses 1-14, wherein determining the decision regarding whether to apply the at least one partition mode comprises: in accordance with a determination that the first and second predicted values are less than a first threshold, determining the decision that a first partition mode and a second partition mode are skipped.

Clause 16. The method of clause 15, wherein determining the decision regarding whether to apply the at least one partition mode further comprises: in accordance with a determination that the first predicted value is less than the first threshold and the second predicted value is larger than or equal to the first threshold and less than a second threshold, determining whether a difference between the first and second predicted values is less than a third threshold; in accordance with a determination that the difference is less than the third threshold, determining the decision that the first partition mode and the second partition mode are skipped; and in accordance with a determination that the difference is larger than or equal to the third threshold, determining the decision that the first partition mode is skipped and the second partition mode is to be applied.

Clause 17. The method of clause 16, wherein the first threshold is 0.3, the second threshold is 0.5 and the third threshold is 0.1.

Clause 18. The method of any of clauses 1-17, wherein determining the decision regarding whether to apply the at least one partition mode comprises: in accordance with a determination that the first and second predicted values are larger than a second threshold, determining whether a difference between the first and second predicted values is less than a fourth threshold; in accordance with a determination that the difference is larger than the fourth threshold, determining the decision that a partition mode of a first and second partition modes corresponding to a smaller predicted value of the first and second predicted values is skipped and another partition mode is to be applied; and in accordance with a determination that the difference is less than or equal to the fourth threshold, determining the decision that the first and second partition modes are to be applied.

Clause 19. The method of clause 18, wherein the second threshold is 0.5 and the fourth threshold is 0.2.

Clause 20. The method of any of clauses 15-19, wherein the first partition mode comprises a horizontal partition mode and the second partition mode comprises a vertical partition mode.

Clause 21. The method of any of clauses 1-20, wherein the conversion includes encoding the video unit into the bitstream.

Clause 22. The method of any of clauses 1-20, wherein the conversion includes decoding the video unit from the bitstream.

Clause 23. An apparatus for video processing comprising a processor and a non-transitory memory with instructions thereon, wherein the instructions upon execution by the processor, cause the processor to perform a method in accordance with any of clauses 1-22.

Clause 24. A non-transitory computer-readable storage medium storing instructions that cause a processor to perform a method in accordance with any of clauses 1-22.

Clause 25. A non-transitory computer-readable recording medium storing a bitstream of a video which is generated by a method performed by an apparatus for video processing, wherein the method comprises: determining a first predicted value associated with at least one tree partition mode according to a first model and based on first feature information of a video unit of the video; determining a second predicted value associated with the at least one tree partition mode according to a second model and based on second feature information of the video unit; determining a decision regarding whether to apply the at least one partition mode for the video unit based on the first predicted value and the second predicted value; and generating the bitstream based on the decision.

Clause 26. A method for storing a bitstream of a video, comprising: determining a first predicted value associated with at least one tree partition mode according to a first model and based on first feature information of a video unit of the video; determining a second predicted value associated with the at least one tree partition mode according to a second model and based on second feature information of the video unit; determining a decision regarding whether to apply the at least one partition mode for the video unit based on the first predicted value and the second predicted value; generating the bitstream based on the decision; and storing the bitstream in a non-transitory computer-readable recording medium.

### Example Device

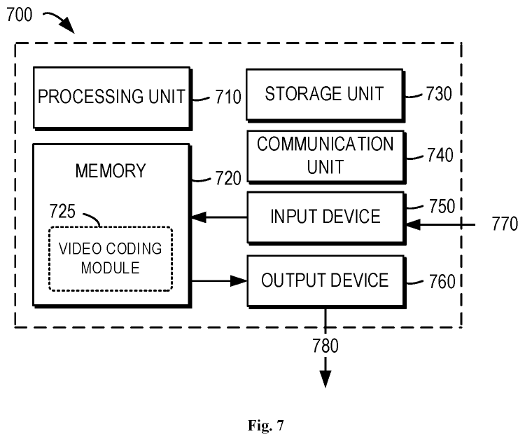

FIG. 7 illustrates a block diagram of a computing device 700 in which various embodiments of the present disclosure can be implemented. The computing device 700 may be implemented as or included in the source device 110 (or the video encoder 114 or 200) or the destination device 120 (or the video decoder 124 or 300).

It would be appreciated that the computing device 700 shown in FIG. 7 is merely for purpose of illustration, without suggesting any limitation to the functions and scopes of the embodiments of the present disclosure in any manner.

As shown in FIG. 7, the computing device 700 includes a general-purpose computing device 700. The computing device 700 may at least comprise one or more processors or processing units 710, a memory 720, a storage unit 730, one or more communication units 740, one or more input devices 750, and one or more output devices 760.

In some embodiments, the computing device 700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 700 can support any type of interface to a user (such as “wearable” circuitry and the like).

The processing unit 710 may be a physical or virtual processor and can implement various processes based on programs stored in the memory 720. In a multi-processor system, multiple processing units execute computer executable instructions in parallel so as to improve the parallel processing capability of the computing device 700. The processing unit 710 may also be referred to as a central processing unit (CPU), a microprocessor, a controller or a microcontroller.

The computing device 700 typically includes various computer storage medium. Such medium can be any medium accessible by the computing device 700, including, but not limited to, volatile and non-volatile medium, or detachable and non-detachable medium. The memory 720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 730 may be any detachable or non-detachable medium and may include a machine-readable medium such as a memory, flash memory drive, magnetic disk or another other media, which can be used for storing information and/or data and can be accessed in the computing device 700.

The computing device 700 may further include additional detachable/non-detachable, volatile/non-volatile memory medium. Although not shown in FIG. 7, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 740 communicates with a further computing device via the communication medium. In addition, the functions of the components in the computing device 700 can be implemented by a single computing cluster or multiple computing machines that can communicate via communication connections. Therefore, the computing device 700 can operate in a networked environment using a logical connection with one or more other servers, networked personal computers (PCs) or further general network nodes.

The input device 750 may be one or more of a variety of input devices, such as a mouse, keyboard, tracking ball, voice-input device, and the like. The output device 760 may be one or more of a variety of output devices, such as a display, loudspeaker, printer, and the like. By means of the communication unit 740, the computing device 700 can further communicate with one or more external devices (not shown) such as the storage devices and display device, with one or more devices enabling the user to interact with the computing device 700, or any devices (such as a network card, a modem and the like) enabling the computing device 700 to communicate with one or more other computing devices, if required. Such communication can be performed via input/output (I/O) interfaces (not shown).

In some embodiments, instead of being integrated in a single device, some or all components of the computing device 700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 700 may be used to implement video encoding/decoding in embodiments of the present disclosure. The memory 720 may include one or more video coding modules 725 having one or more program instructions. These modules are accessible and executable by the processing unit 710 to perform the functionalities of the various embodiments described herein.

In the example embodiments of performing video encoding, the input device 750 may receive video data as an input 770 to be encoded. The video data may be processed, for example, by the video coding module 725, to generate an encoded bitstream. The encoded bitstream may be provided via the output device 760 as an output 780.

In the example embodiments of performing video decoding, the input device 750 may receive an encoded bitstream as the input 770. The encoded bitstream may be processed, for example, by the video coding module 725, to generate decoded video data. The decoded video data may be provided via the output device 760 as the output 780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

What is claimed is:

1. A method of video processing, comprising:
determining, for a conversion between a video unit of a video and a bitstream of the video, a first predicted value associated with at least one partition mode according to a first model and based on first feature information of the video unit;
determining a second predicted value associated with the at least one partition mode according to a second model and based on second feature information of the video unit;
determining a decision regarding whether to apply the at least one partition mode for the video unit based on the first predicted value and the second predicted value; and
performing the conversion based on the decision.

2. The method of claim 1, further comprising:
constructing the first model in a horizontal direction; and
constructing the second model in a vertical direction.

3. The method of claim 2, wherein the first model comprises six neurons in an input layer, two hidden layers of fifteen neurons in a middle layer and one neural in an output layer, and the second model comprises five neurons in an input layer, two hidden layers of fifteen neurons in a middle layer and one neural in an output layer.

4. The method of claim 1, wherein the first and second models are offline trained separately, and/or
wherein the first and second models are fully connected network models.

5. The method of claim 1, further comprising:
storing coding information for extracting a dataset; and
performing a correlation analysis on the dataset to determine the first feature information and the second feature information from the coding information.

6. The method of claim 5, wherein the coding information comprises encoding information, the dataset further stores optimal partitioning information, and the first feature information and the second feature information are selected based on correlation information of the encoding information and the optimal partitioning information,
wherein the correlation information is determined by a heatmap feature analysis based on the encoding information and the optimal partitioning information in the dataset.

7. The method of claim 1, wherein the first feature information comprises at least one of: a quantization parameter (QP), a quadtree multi-type tree (QTMT) depth, a coding block flag (CBF), a mean of residuals, a residual variance comparison value, or a horizontal-vertical gradient comparison value.

8. The method of claim 1, wherein the first feature information comprises at least one of: a quantization parameter (QP), a quadtree multi-type tree (QTMT) depth, a vertical gradient, a mean of residuals, or a horizontal-vertical gradient comparison value.

9. The method of claim 8, wherein the vertical gradient represents a motion trend in a vertical direction, and the vertical gradient is determined by:
$${G}_{v} = {\sum }_{i = 0}^{H - 1} {\sum }_{j = 0}^{W - 1} \vert {O}_{i + 1 , j} - {O}_{i , j} \vert ,$$
wherein Gᵥ represents the vertical gradient, H and W represent a height and a width of the video unit, and O_{i,j} represents a luma value of a pixel point (i, j).

10. The method of claim 7, wherein the mean of residuals represents a predicted change in pixel values, and the mean of residuals is determined by: R_{i,j}=|P_{i,j}−O_{i,j}|, wherein R_{i,j} denotes a residual value of a pixel point (i, j), P_{i,j} denotes a prediction value of the pixel point (i, j), and O_{i,j} denotes a luma value of the pixel point (i, j).

11. The method of claim 7, wherein the residual variance comparison value is based on a horizontal feature and a vertical feature, the horizontal feature and the vertical feature being determined by:
$$HCom\_Var = \{ \begin{matrix}0 , & Var\_H > Var\_V \\ 1 , & Var\_H < Var\_V\end{matrix}$$
$$VCom\_Var = \{ \begin{matrix}0 , & Var\_V > Var\_H \\ 1 , & Var\_V < Var\_H\end{matrix} ,$$
wherein Var_H represents a horizontal maximum subblock residual variance, Var_V represents a vertical maximum subblock residual variance, HCom_Var represents the horizontal feature, and VCom_Var represents the vertical feature.

12. The method of claim 7, wherein the horizontal-vertical gradient comparison value is based on a horizontal value and a vertical value, the horizontal value and the vertical value being determined by:
$$HCom\_Grad = \{ \begin{matrix}0 , & {G}_{h} > {G}_{v} \\ 1 , & {G}_{h} < {G}_{v}\end{matrix}$$
$$VCom\_Grad = \{ \begin{matrix}0 , & {G}_{v} > {G}_{h} \\ 1 , & {G}_{v} < {G}_{h}\end{matrix} ,$$
wherein Gₕ represents a horizontal gradient, Gᵥ represents a vertical gradient, HCom_Grad represents the horizontal value, and VCom_Grad represents the vertical value.

13. The method of claim 1, wherein determining the decision regarding whether to apply the at least one partition mode comprises:
in accordance with a determination that the first and second predicted values are less than a first threshold, determining the decision that a first partition mode and a second partition mode are skipped.

14. The method of claim 13, wherein determining the decision regarding whether to apply the at least one partition mode further comprises:
in accordance with a determination that the first predicted value is less than the first threshold and the second predicted value is larger than or equal to the first threshold and less than a second threshold, determining whether a difference between the first and second predicted values is less than a third threshold;
in accordance with a determination that the difference is less than the third threshold, determining the decision that the first partition mode and the second partition mode are skipped; and
in accordance with a determination that the difference is larger than or equal to the third threshold, determining the decision that the first partition mode is skipped and the second partition mode is to be applied,
wherein the first threshold is 0.3, the second threshold is 0.5 and the third threshold is 0.1.

15. The method of claim 1, wherein determining the decision regarding whether to apply the at least one partition mode comprises:
in accordance with a determination that the first and second predicted values are larger than a second threshold, determining whether a difference between the first and second predicted values is less than a fourth threshold;
in accordance with a determination that the difference is larger than the fourth threshold, determining the decision that a partition mode of a first and second partition modes corresponding to a smaller predicted value of the first and second predicted values is skipped and another partition mode is to be applied; and
in accordance with a determination that the difference is less than or equal to the fourth threshold, determining the decision that the first and second partition modes are to be applied,
wherein the second threshold is 0.5 and the fourth threshold is 0.2.

16. The method of claim 1, wherein the first partition mode comprises a horizontal partition mode and the second partition mode comprises a vertical partition mode.

17. The method of claim 1, wherein the conversion includes encoding the video unit into the bitstream, or
wherein the conversion includes decoding the video unit from the bitstream.

18. The method of claim 1, wherein the conversion comprises: generating the bitstream from the video, and
the method further comprises: storing the bitstream in a non-transitory computer-readable recording medium.

19. An apparatus for video processing comprising a processor and a non-transitory memory with instructions thereon, wherein the instructions upon execution by the processor, cause the processor to:
determine, for a conversion between a video unit of a video and a bitstream of the video, a first predicted value associated with at least one partition mode according to a first model and based on first feature information of the video unit;
determine a second predicted value associated with the at least one partition mode according to a second model and based on second feature information of the video unit;
determine a decision regarding whether to apply the at least one partition mode for the video unit based on the first predicted value and the second predicted value; and
perform the conversion based on the decision.

20. A non-transitory computer-readable storage medium storing instructions that cause a processor to perform operations comprising:
determining, for a conversion between a video unit of a video and a bitstream of the video, a first predicted value associated with at least one partition mode according to a first model and based on first feature information of the video unit;
determining a second predicted value associated with the at least one partition mode according to a second model and based on second feature information of the video unit;
determining a decision regarding whether to apply the at least one partition mode for the video unit based on the first predicted value and the second predicted value; and
performing the conversion based on the decision.
